(19) United States
(12) Patent Application Publication
(10) Pub. No.: US 2005/0063126 A1
(43) Pub. Date: Mar. 24, 2005

(54) Surge cancel apparatus

(76) Inventor: Doo-sik Joo, Seoul (KR)

Correspondence Address: STANZIONE & KIM, LLP, 1740 N STREET, N.W., FIRST FLOOR, WASHINGTON, DC, 20036, US

(21) Appl. No.: 10/937,428

(22) Filed: Sep. 10, 2004

(30) Foreign Application Priority Data
Sep. 20, 2003 (KR) 2003-65411

(51) Int. Cl. H02H 9/06

(52) U.S. Cl. 361/118

(57) ABSTRACT

A surge cancel apparatus. The surge cancel apparatus may include a pair of first input terminals, and various arrangements and numbers of common mode surge cancellers and normal mode surge cancellers to cancel various surges from external sources. The surge cancel apparatus can cancel external surges using a set ground even when an earth ground does not exist. The surge cancel apparatus is applicable to a circuit such as a facsimile so that the surge cancel apparatus cancels surges inflowing to a primary side to protect a secondary side.

### CROSS-REFERENCE TO RELATED APPLICATIONS

This application claims the priority of Korean Patent Application No. 2003-65411, filed on Sep. 20, 2003, in the Korean Intellectual Property Office, the disclosure of which is incorporated herein in its entirety by reference.

### BACKGROUND OF THE INVENTION

1. Field of the Invention

The present general inventive concept relates to a circuit capable of being effected by external surges, such as a facsimile or a multi function peripheral performing the operations of a facsimile, and more particularly, to a surge cancel apparatus which is included in such a circuit and cancels surges.

2. Description of the Related Art

A conventional surge cancel apparatus uses an earth ground in order to cancel surges inflowing from an external source.

For example, the primary side (not shown) of a power input terminal that is included in a circuit such as a facsimile, receives a supply voltage from an external source, that is, an alternating-current (AC) voltage, converts the AC voltage to a direct-current (DC) voltage, and transfers the converted DC voltage to the secondary side. Also, the primary side includes a surge cancel apparatus acting to cancel surges in order to protect the secondary side from surges inflowing from an external source. Similarly, the primary side of a signal input terminal that is included in a circuit such as a facsimile, and receives signals from an exchange, includes a surge cancel apparatus in order to protect the secondary side from external surges.

As described above, the conventional surge cancel apparatus, which is mounted on the primary side to cancel surges, includes a surge canceller, such as a gas tube, between a tip and a ring, between the tip and an earth ground, and/or between the ring and the earth ground. However, if the earth ground does not exist, since the conventional surge cancel apparatus cannot cancel external surges, the secondary side cannot be protected from the external surges. When the earth ground does not exist, if excessive energy inflows to the primary side, energy exceeding the withstanding voltage of the primary side is transferred to the secondary side, which can destroy the secondary side.

### SUMMARY OF THE INVENTION

Accordingly, it is an aspect of the present general inventive concept to provide a surge cancel apparatus capable of canceling surges even when an earth ground does not exist.

Additional aspects and advantages of the present general inventive concept will be set forth in part in the description which follows and, in part, will be obvious from the description, or may be learned by practice of the invention.

The foregoing and/or other aspects of the present general inventive concept are achieved by providing a surge cancel apparatus that may include a pair of first input terminals and a first common mode surge canceller, which is connected between one first input terminal of the first input terminals and a set ground and cancels surges inflowing between the first input terminal and the set ground.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a surge cancel apparatus according to several embodiments of the present general inventive concept;

FIG. 2 is a block diagram of a surge cancel apparatus according to several embodiments of the present general inventive concept;

FIG. 3 is a circuit diagram schematically showing portions capable of being connected with output terminals shown in FIG. 1 or FIG. 2; and

FIG. 4 is a circuit diagram of a surge cancel apparatus according to several embodiments the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

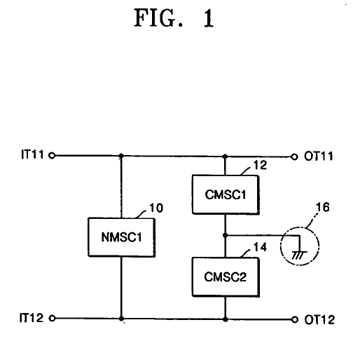

FIG. 1 is a block diagram of a surge cancel apparatus according to several embodiments of the present general inventive concept. The surge cancel apparatus can include a first normal mode surge canceller (NMSC1) 10 and first and second common mode surge cancellers (CMSC1 and CMSC2) 12 and 14, respectively, or combinations thereof.

According to an embodiment of FIG. 1, a surge cancel apparatus can include only the first common mode surge canceller (CMSC1) 12 shown in FIG. 1. Here, the first common mode surge canceller (CMSC1) 12 can be connected between a first input terminal IT11 of first and second input terminals IT11 and IT12 and a set ground 16 and cancels surges inflowing between the first input terminal IT11 and the set ground 16. The surges, for example, may be electrical over stress (EOS) caused by lightning, etc.

According to another embodiment of FIG. 1, a surge cancel apparatus can include a second common mode surge canceller (CMSC2) 14 in addition to the first common mode surge canceller (CMSC2) 12 shown in FIG. 1. Here, the second common mode surge canceller (CMSC2) 14 can be connected between the second input terminal IT12 of the first and second input terminals IT11 and IT12 and the set ground 16 and cancels surges inflowing between the second input terminal IT12 and the set ground 16.

According to another embodiment of FIG. 1, a surge cancel apparatus can include the first normal mode surge canceller (NMSC1) 10 in addition to at least one of the first and second common mode surge cancellers (CMSC1 and CMSC2) 12 and 14 shown in FIG. 1. Here, the first normal mode surge canceller (NMSC1) 10 of this embodiment can be connected between the first and second input terminals IT11 and IT12 and cancels surges inflowing between the first and second input terminals IT11 and IT12.

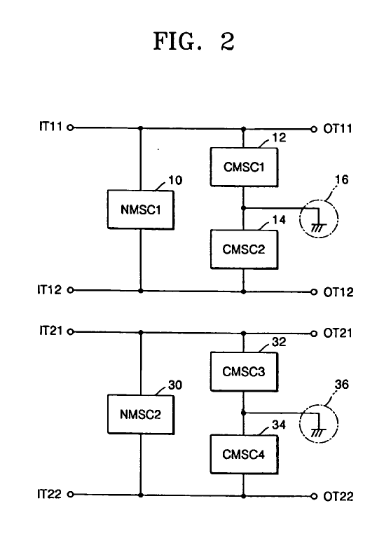

FIG. 2 is a block diagram of a surge cancel apparatus according several embodiments of the present general inventive concept. The surge cancel apparatus according to the embodiments of FIG. 2 can include first and second normal mode surge cancellers (NMSC1 and NMSC2) 10 and 30, and first, second, third, and fourth common mode surge cancellers (CMSC1, CMSC2, CMSC3, and CMSC4) 12, 14, 32, and 34, or combinations thereof.

The same components included in FIGS. 1 and 2 are denoted by the same reference number or by the same reference sign. For example, the first and second input terminals IT11 and IT12, the first normal mode surge canceller (NMSC1) 10, the first and second common mode surge cancellers (CMSC1 and CMSC2) 12 and 14, and the set ground 16, which are shown in FIG. 2, correspond respectively to the first input terminals IT11 and IT12, the first normal mode surge canceller (NMSC1) 10, the first and second common mode surge cancellers (CMSC1 and CMSC2) 12 and 14, and the set ground 16, which are shown in FIG. 1, and therefore the detailed descriptions thereof are omitted.

According to another embodiment of FIG. 2, a surge cancel apparatus can include a third common mode surge canceller (CMSC3) 32 in addition to the component(s) according to the above-described embodiments of FIG. 1. Here, the third common mode surge canceller (CMSC3) 32 can be connected between a third input terminal IT21 and the set ground 36 and cancels surges inflowing between the third input terminal IT21 and the set ground 36.

According to another embodiment of FIG. 2, a surge cancel apparatus can include a fourth common mode surge canceller (CMSC4) 34 in addition to the components according to the previous embodiment of FIG. 2. The fourth common mode surge canceller (CMSC4) 34 can be connected between a fourth input terminal IT22 and the set ground 36 and cancels surges inflowing between the fourth input terminal IT22 and the set ground 36.

According to another embodiment of FIG. 2, a surge cancel apparatus can include a second normal mode surge canceller (NMSC2) 30 in addition to the components according to the previous embodiment. The second normal mode surge canceller (NMSC2) 30 can be connected between the third and fourth input terminals IT21 and IT22 and cancels surges inflowing between the third and fourth input terminals IT21 and IT22, respectively.

Meanwhile, according to another embodiment of the present general inventive concept, the first and second input terminals IT11 and IT12 shown in FIG. 1 or 2 can correspond to a tip connector and a ringconnector, respectively. Alternately, the first and second input terminals IT11 and IT12 shown in FIG. 1 or 2 can correspond to a ring connector and a tip connector, respectively. In this case, the first and second input terminals IT11 and IT12 shown in FIG. 1 or 2 can be connected to an exchange (not shown). Accordingly, signals transmitted from the exchange can be received through the ring and the tip connectors.

According to another embodiment of the present general inventive concept, the first and second input terminals IT11 and IT12 shown in FIG. 1 or 2 can correspond to a hot (or live) terminal and a neutral terminal, respectively. Alternately, the first and second input terminals IT11 and IT12 shown in FIG. 1 or 2 can correspond to a neutral terminal and a hot (or live) terminal, respectively. In this case, the first and second input terminals IT11 and IT12 shown in FIG. 1 can be connected to an external power source. Accordingly, a supply voltage supplied from an external power source can be received through the hot and the neutral terminals.

According to another embodiment of the present general inventive concept, the third and fourth input terminals IT21 and IT22 shown in FIG. 2 correspond to a hot (or live) terminal and a neutral terminal, respectively. Alternately, the third and fourth input terminals IT21 and IT22 shown in FIG. 2 can correspond to a neutral terminal and a hot (or live) terminal, respectively.

According to another embodiment of the present general inventive concept, the third and fourth input terminals IT21 and IT22 shown in FIG. 2 can correspond to a ring connector and a tip connector, respectively. Alternately, the third and fourth input terminals IT21 and IT22 shown in FIG. 2 can correspond to a tip connector and a ring connector, respectively.

Accordingly, in a case where the first and second input terminals IT11 and IT12 shown in FIG. 2 are implemented as in the embodiment described above where the first and second input terminals IT11 and IT12 of FIG. 1 or FIG. 2 correspond to a tip connector and a ring connector, respectively, or vice versa, the third and fourth input terminals IT21 and IT22 shown in FIG. 2 can be implemented as in the embodiment where the third and fourth input terminals IT21 and IT22 of FIG. 2 correspond to a hot terminal and a neutral terminal, respectively, or vice versa. Also, in a case where the first and second input terminals IT11 and IT12 shown in FIG. 2 are implemented as in the above described embodiment where the first and second input terminals IT11 and IT12 of FIG. 1 or FIG. 2 correspond to a hot terminal and a neutral terminal, respectively, or vice versa, the third and fourth input terminals IT21 and IT22 shown in FIG. 2 can be implemented as in the above described embodiment where third and fourth input terminals IT21 and IT22 shown in FIG. 2 corresponding to a ring connector and a tip connector, respectively, or vice versa.

Meanwhile, a surge cancel apparatuses according to the present general inventive concept is not limited to the surge cancel apparatus shown in FIG. 1 or 2. A surge cancel apparatus according to the present general inventive concept can be implemented by a set consisting of all components (10, 12, and 14) shown in FIG. 1, can be implemented by two sets each consisting of the all components shown in FIG. 1, as shown in FIG. 2, or can be implemented by a plurality of sets (above three sets) each consisting of the all components shown in FIG. 1. Each set implementing a surge cancel apparatus includes at least one of the above-described two common mode surge cancellers and can further include a normal mode surge canceller.

The surge cancel apparatus according to the present general inventive concept shown in FIG. 1 can output a signal or a supply voltage received through the first and second input terminals IT11 and IT12 to a portion (not shown) connected to first and second output terminals OT11 and OT12. Also, the surge cancel apparatus according to FIG. 2 outputs a signal or a supply voltage received through the first and second input terminals IT11 and IT12 to a portion (not shown) connected to output terminals OT11 and OT12, and outputs a supply voltage or a signal received through the third and fourth input terminals IT21 and IT22 to a portion (not shown) connected to third and fourth output terminals OT21 and OT22.

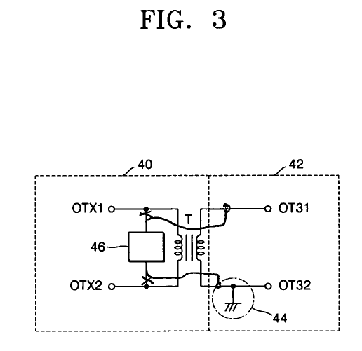

FIG. 3 is a circuit diagram schematically showing the portions capable of being connected to the output terminals (OT11 and OT12) or (OT11, OT12, OT21, and OT22) shown in FIG. 1 or 2, wherein the portions can be implemented by a rectifier 46 and a transformer T.

Output terminals OTX1 and OTX2 shown in FIG. 3 may be the first and second output terminals OT11 and OT12 shown in FIG. 1 or 2, or may be the third and fourth output terminals OT21 and OT22 shown in FIG. 2. That is, X=1 or 2.

For example, if input terminals ITX1 and ITX2 correspond to a ring connector and a tip connector, respectively, the rectifier 46 shown in FIG. 3 can be omitted. In this case, signals inflowing to an exchange (not shown), etc. from an external source through the ring and tip connectors are transferred through the output terminals OTX1 and OTX2 to the secondary side 42 via the transformer T. Here, the primary side 40 can include any form of the surge cancel apparatuses shown in FIG. 1 or 2 and the transformer T, and transfers signals received through the tip and the ring connectors from an external source to the secondary side 42. The secondary side 42 performs its unique operations, for example, the operations of a facsimile, etc. using the signals transmitted from the primary side 40.

Alternately, if the input terminals ITX1 and ITX2 can correspond to a hot (or live) terminal and a neutral terminal, respectively, the rectifier 46 shown in FIG. 3 can be included. A supply voltage inflowing through the hot and neutral terminals from an external source, such as an AC voltage applied between the output terminals OTX and OTX2 rectified by the rectifier 46, then can be converted to a predetermined DC voltage by the transformer T, and is output to the secondary side 42 through output terminals OT31 and OT32. Here, the primary side 40 includes the surge cancel apparatus shown in FIG. 1 or 2, the rectifier 46, and the transformer T. The primary side 40 converts an external AC voltage received through the hot and neutral terminals to a DC voltage capable of being used in the secondary side 42, and transfers the DC voltage to the secondary side 42. Here, the secondary side 42 performs its unique operations using the DC voltage transferred from the primary side 40.

As a result, the primary side 40 acts to protect the secondary side 42 from surges. Here, if the primary side 40 acts to receive signals instead of receiving the supply voltage, the primary side 40 also acts to match impedance between the exchange (not shown) and the secondary side 42. Here, the set ground 16 or 36 shown in FIG. 1 or 2 corresponds to a set ground 44 mounted on the secondary side 42 shown in FIG. 3.

Meanwhile, the first, second, third, or fourth common mode surge canceller (CMSC1, CMSC2, CMSC3, or CMSC4), the first or second normal mode surge canceller (NMSC1 or NMSC2) 12, 14, 32, 34, 10, or 30, which are shown in FIG. 1 or 2, may be a varistor or gas tube.

Meanwhile, the above-described surge cancel apparatuses according to the present general inventive concept can be applicable to a facsimile (not shown) or a multi function peripheral (not shown) capable of performing the operations of a facsimile. In this case, the first and second input terminals IT11 and IT12 correspond to the ring and the tip, respectively, and the third and fourth input terminals IT21 and IT22 correspond to the hot and the neutral, respectively.

Hereinafter, the configuration and operations of the surge cancel apparatuses according to the present general inventive concept, capable of being installed in a facsimile or a multi function peripheral with facsimile operations, will be described with reference to the appended drawings as follows.

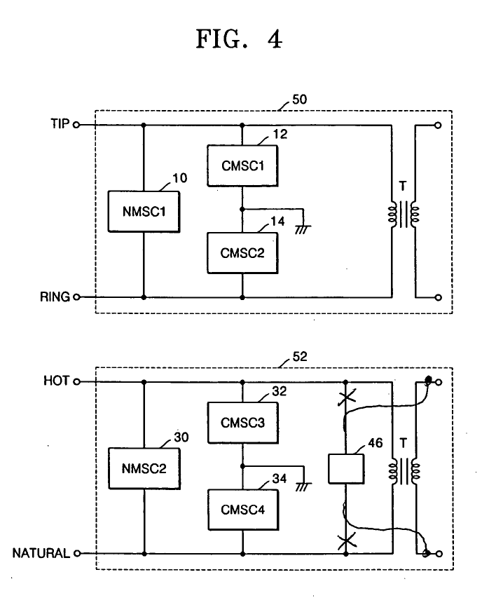

FIG. 4 is a circuit diagram of a surge cancel apparatus according to an embodiment of the present general inventive concept. The surge cancel apparatus can include a signal input unit 50 and a power source unit 52. Here, the same components included in FIGS. 2 and 4 are denoted by the same reference number or by the same reference signs.

The signal input unit 50 shown in FIG. 4 includes the first normal mode surge canceller (NMSC1) 10 and the first and second common mode surge cancellers (CMSC1 and CMSC2) 12 and 14 shown in FIG. 2, and the portion excluding the rectifier 46 from the circuit shown in FIG. 3. The signal input unit 50 with this configuration allows an exchange (not shown) to communicate with data for facsimile transmission through the tip and the ring connectors, for example, via a Public Switched Telephone Network (PSTN), etc. In this case, the signal input unit 50 may be a line interface unit (LIU) that is connected to the facsimile through a modem (not shown), etc.

Also, the power source unit 52 shown in FIG. 4 can include the second normal mode surge canceller (NMSC2) 30 and the third and fourth common mode surge cancellers (CMSC3 and CMSC4) 32 and 34 shown in FIG. 2, and the circuit shown in FIG. 3. The power source unit 52 with this configuration acts to receive an external supply voltage received through the hot and neutral and supply the supply voltage to the facsimile. The power source unit 52 may be a switching mode power supply (SMPS) of a facsimile.

As described above, the surge cancel apparatuses according to the present general inventive concept can cancel external surges using a set ground even when an earth ground does not exist. The surge cancel apparatuses are applicable to a circuit such as a facsimile so that the surge cancel apparatus cancels surges inflowing to the primary side to protect the secondary side.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A surge cancel apparatus comprising:
a first input terminal and a second input terminal; and
a first common mode surge canceller connected between the first input terminal and a set ground and cancels surges between the first input terminal and the set ground.

2. The apparatus of claim 1, further comprising a second common mode surge canceller connected between the second input terminal and the set ground to cancel surges between the second input terminal and the set ground.

3. The apparatus of claim 1, further comprising a first normal surge canceller connected between the first input terminal and the second input terminal to cancel surges between the first input terminal and the second input terminal.

4. The apparatus of claim 2, further comprising a first normal surge canceller connected between the first input terminal and the second input terminal to cancel surges between the first input terminal and the second input terminal.

5. The apparatus of claim 1, further comprising:
a third input terminal and a fourth input terminal; and
a third common mode surge canceller connected between the third input terminal and the set ground to cancel surges between the third input terminal and the set ground.

6. The apparatus of claim 5, further comprising a fourth common mode surge canceller connected between the fourth input terminal and the set ground to cancel surges between the fourth input terminal and the set ground.

7. The apparatus of claim 5, further comprising a second normal mode surge canceller connected between the third input terminal and the fourth input terminal to cancel surges between the third input terminal and the fourth input terminal.

8. The apparatus of claim 6, further comprising a second normal mode surge canceller connected between the third input terminal and the fourth input terminal to cancel surges between the third input terminal and the fourth input terminal.

9. The apparatus of claim 1, wherein the first input terminal and the second input terminal correspond to a tip connector and a ring connector, respectively.

10. The apparatus of claim 1, wherein the first input terminal and the second input terminal correspond to a hot terminal and a neutral terminal, respectively.

11. The apparatus of claim 5, wherein the first input terminal and the second input terminal correspond to a tip connector and a ring connector, respectively, and the third input terminal and the fourth input terminal correspond to a hot terminal and a neutral terminal, respectively.

12. The apparatus of claim 9, wherein the set ground is mounted on a secondary side, the secondary side receives a signal transmitted from a primary side, and the primary side transfers an external signal received through the tip connector and the ring connector to the secondary side.

13. The apparatus of claim 910, wherein the set ground is mounted on a secondary side, the secondary side receives a direct-current voltage transferred from a primary side, and the primary side converts an external alternating-current voltage received through a hot terminal and a neutral terminal to the direct-current voltage and transfers the direct-current voltage to the secondary side.

14. The apparatus of claim 3, wherein each of the first normal mode surge canceller and the first common mode surge canceller is a varistor.

15. The apparatus of claim 3, wherein each of the first normal mode surge canceller and the first common mode surge canceller is a gas tube.

16. The apparatus of claim 7, wherein each of the third common mode surge canceller and the second normal mode surge canceller is a varistor.

17. The apparatus of claim 7, wherein each of the third common mode surge canceller and the second normal mode surge canceller is a gas tube.

18. A surge cancel method, comprising:
connecting a first common mode surge canceller between a first input terminal and a set ground; and
canceling a surge between the first input terminal and the set ground.

19. The method of claim 18, further comprising:
connecting a second common mode surge canceller between a second input terminal and the set ground; and
canceling surges between the second input terminal and the set ground.

20. The method of claim 19, further comprising:
connecting a first normal surge canceller between the first input terminal and the second input terminal; and
canceling surges between the first input terminal and the second input terminal.
